(19) United States
(12) Patent Application Publication
(10) Pub. No.: US 2015/0176788 A1
(43) Pub. Date: Jun. 25, 2015

(54) STAGE REPRESENTATION DEVICE AND STAGE REPRESENTATION METHOD

(71) Applicant: ISA CO., LTD., Yokohama-shi (JP)

(72) Inventor: Kiyoshi ISAYAMA, Tokyo (JP)

(21) Appl. No.: 14/571,535

(22) Filed: Dec. 16, 2014

(30) Foreign Application Priority Data
Oct. 18, 2013 (JP) 2013-217544

(51) Int. Cl. F21S 10/00; F21V 21/008; F21S 8/00; F21V 14/04

(52) U.S. Cl. CPC F21S 10/00; F21V 14/04; F21V 21/008; F21S 8/03; F21W 2131/406

(57) ABSTRACT

Representation as if there is a spotlight in air is flexibly performed. A stage representation device vertically moves a plurality of reflecting members each connected to a suspension line and reflecting light from a spotlight at a predetermined position in the air of a stage and adjusts the reflecting member to a predetermined angle. By means of reflection by the reflecting member, the stage looks as if the spotlight is emitted from the air for audience.

### BACKGROUND OF THE INVENTION

1. Field of the Invention

The present invention relates to a stage representation device and a stage representation method used on a stage of a theater, a concert hall, a TV studio or the like.

2. Description of the Related Art

There is known a representation system in which a plurality of lighting devices emitting light to performers, stage settings and the like is suspended from a ceiling part of the stage of a theater, a concert hall, a TV studio or the like and the suspended plurality of lighting devices is elevated up/down (see Japanese Patent Laid-Open No. 11-135270, for example).

However, lighting devices are heavy, and a mechanism for suspending the lighting device is also a robust mechanism for supporting the lighting device. Therefore, it is difficult to perform representation by frequently elevating up/down the lighting device during stage representation.

### SUMMARY OF THE INVENTION

A stage representation device according to the present invention has a spotlight installed on at least one of a ceiling, a wall, and a floor of a space in which a stage is performed, a reflecting member connected to a suspension line and reflecting light from the spotlight, an elevating unit configured to move vertically the plurality of reflecting members in the air in which the stage is performed by using the plurality of suspension lines, and a rotating unit configured to rotate the reflecting member in the air in which the stage is performed.

According to the present invention, representation as if there is a spotlight in the air can be flexibly performed.

Further features of the present invention will become apparent from the following description of exemplary embodiments (with reference to the attached drawings).

### BRIEF DESCRIPTION OF THE DRAWINGS

FIG. 1 is a view illustrating an example of a configuration of a stage representation device according to an embodiment 1;

FIG. 2 is a view illustrating a part of an elevating device and a reflecting member according to the embodiment 1;

FIG. 3 is a view illustrating an example of stage representation according to the embodiment 1;

FIG. 4 is a view illustrating an example of the stage representation according to the embodiment 1; and

FIG. 5 is a view illustrating a part of an elevating device and a reflecting member according to an embodiment 2.

### DESCRIPTION OF THE EMBODIMENTS

Embodiments according to the present invention will be described below in detail by using the attached drawings. However, constituent elements described in the embodiments are only exemplification and are not intended to limit a range of the invention.

### Embodiment 1

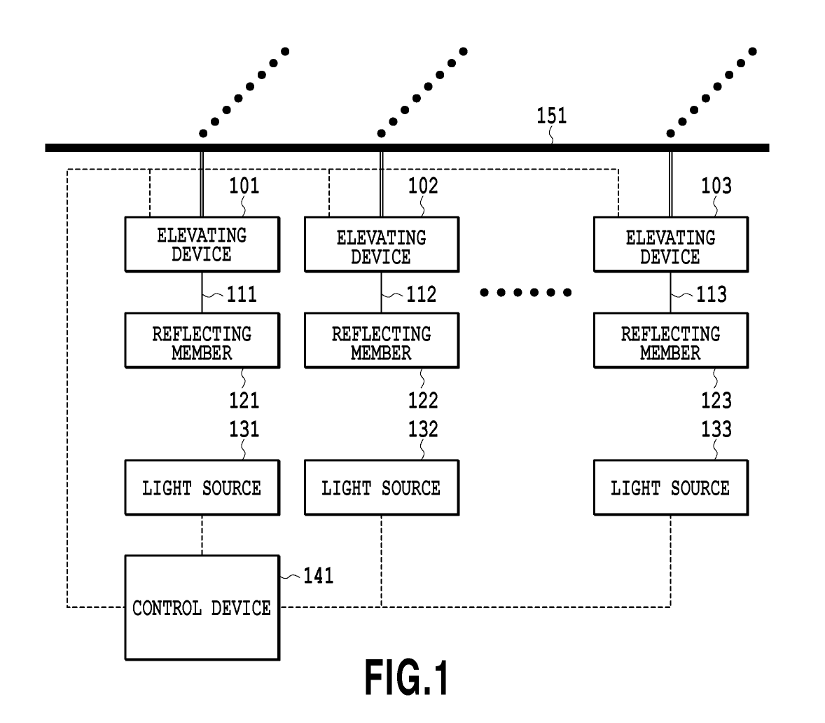

FIG. 1 is a view illustrating an example of a stage representation device according to an embodiment 1. The stage representation device is used on a stage of a theater, a concert hall, a TV studio or the like. Moreover, it can be used anywhere whether it is outdoor or indoor. Examples illustrated below will be described assuming that the stage representation device is used in an indoor concert hall.

The stage representation device illustrated in FIG. 1 has elevating devices 101 to 103, suspension lines 111 to 113 connected to the elevating devices 101 to 103, respectively, reflecting members 121 to 123 connected to the suspension lines 111 to 113, respectively, light sources 131 to 133 for emitting light to the reflecting members 121 to 123, a control device 141 for controlling the elevating devices 101 to 103 and the light sources 131 to 133, and a baton 151 from which the elevating devices are suspended.

Here, an example in which the elevating devices, the reflecting members, and the light sources are each provided in three is shown for simplification of the explanation, but the present invention is not limited to that. Moreover, the example in which only one baton 151 is provided is illustrated, but a plurality of batons may be provided on which the plurality of lighting devices, reflecting members, and light sources are provided, respectively. Moreover, the light source is provided so that one light source corresponds to one reflecting member, but this is not limiting. Light from the plurality of light sources may be emitted to one reflecting member.

The elevating device 101 is connected to the suspension line 111. The suspension line 111 is a line for suspending the reflecting member 121. The suspension line 111 can be constituted by a reel wire such as a nylon synthetic fiber, for example. The elevating device 101 elevates up/down the reflecting member 121 by winding up or lowering down the suspension line by driving a motor in accordance with control from the control device 141. Moreover, the elevating device 101 is constituted capable of adjusting an angle of light reflected from the reflecting member by rotating the reflecting member 121 through the suspension line 111. The same applies to the elevating devices 102 and 103 and the suspension lines 112 and 113.

The reflecting member 121 is constituted by a member reflecting light. The reflecting member 121 can be constituted by an acrylic mirror, for example. Moreover, the reflecting member 121 is vertically moved by control of the elevating device 101. Moreover, the reflecting member 121 is rotated by control of the elevating device 101. By means of this rotation operation, the reflecting member 121 changes an angle of the reflected light. The same applies to the reflecting members 122 and 123.

The light source 131 is constituted capable of emitting light to the reflecting member 121. It is needless to say that the light source 131 may emit light to the other reflecting members 122 and 123 or may emit light onto the stage, and a light emitting direction may be changed as appropriate. Here, explanation will be made assuming that at least the light source 131 emits light to the reflecting member 121. The light source 131 can be constituted by a spotlight used for a stage, for example.

The control device 141 controls the elevating devices 101 to 103 and the light sources 131 to 133. The control device 141 instructs a winding-up amount, a lowering-down amount and their timing of the suspension line to the elevating device, for example. The elevating device performs winding up/down of the suspension line in accordance with this instruction.

Moreover, the control device instructs an angle of the reflecting member to the elevating device. For example, it inputs predetermined angles such as 0 degrees in a horizontal direction, 90 degrees for a ceiling, and −90 degrees for the floor of the stage. Moreover, it similarly inputs predetermined angles regarding a perpendicular direction. As will be described later, the reflecting member is suspended by three suspension lines in this embodiment, and the reflecting member is rotated by adjusting a height of each of the suspension lines. Therefore, the control device instructs the height of each of the suspension lines on the basis of the input angle to the elevating device.

As described above, in this embodiment, the control device instructs a winding-up amount or a lowering-down amount of the suspension line to the elevating device on the basis of the height of the reflecting member in the air of the stage and the angle of the reflecting member. Moreover, the control device individually gives an instruction to each of the elevating devices. Therefore, each of the elevating devices can vertically move or rotate the reflecting member at arbitrary timing.

The control device also instructs emitting timing, an emitting amount, an emitting direction and the like of the light to the light source.

The instruction from the control device to the elevating device and the light source is sent as appropriate through a signal line connected to each of the devices and the light source. It may be so configured that a wireless module is connected to these devices and light sources so that instructions from the control device to the elevating devices and the light sources are given wirelessly. Alternatively, it may be so configured that the elevating device and the light source have a memory for storing these instructions in advance or the like so that the above-described control is executed in accordance with the instructions stored from the control device in the memory in advance. The control device temporally changes a position and an angle of the reflecting member and the emitting direction, the emitting amount and the like of the light source on the basis of various programs according to representation. As a result, the position and the angle of the reflecting member are dynamically changed, and the light from the light source enters the reflecting member at arbitrary timing. It is needless to say that the control device gives such an instruction that the reflecting member is fixed to a predetermined position or angle for a predetermined period of time.

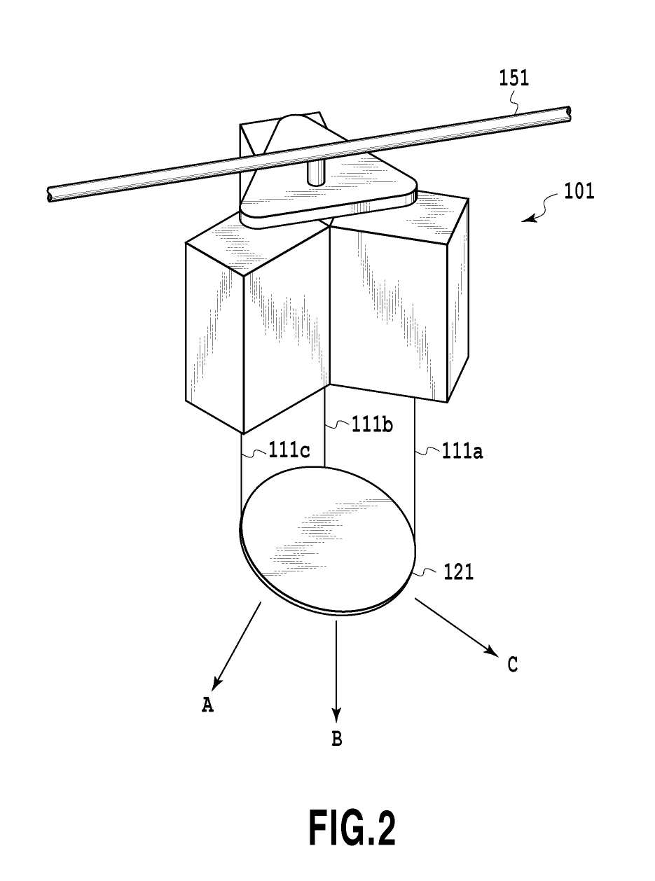

Subsequently, a specific example of the elevating device and the reflecting member of this embodiment will be described. FIG. 2 is a view illustrating a specific example of the elevating device 101, the suspension line 111, and the reflecting member 121.

As illustrated in FIG. 2, the suspension line 111 is constituted by three suspension lines 111a, 111b, and 111c. The elevating device 101 includes a motor or the like, not shown, corresponding to each of the suspension lines in the housing so that each of the suspension lines can be individually elevated up/down.

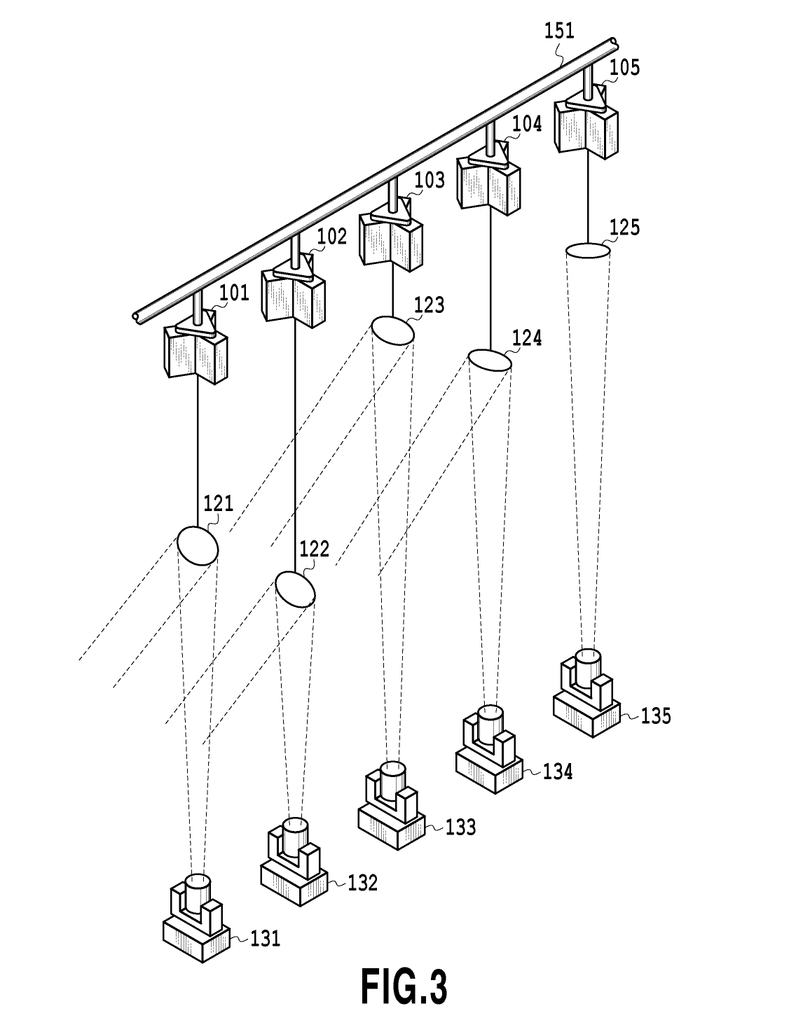

The reflecting member 121 is constituted by a circular acrylic mirror and has a diameter of approximately 30 cm, a thickness of 7 mm, and a weight of 200 g in this embodiment. The reflecting member 121 is an acrylic mirror both on a front surface and a rear surface. Here, it is assumed that the light source is installed immediately below the reflecting member 121. In this case, by setting the suspension line 111b at a position lower than the other suspension lines, the light emitted from below is reflected in a B direction illustrated in FIG. 2. Moreover, by setting the suspension line 111a at a position lower than the other suspension lines, the light emitted from below is reflected in an A direction illustrated in FIG. 3. Moreover, by setting the suspension line 111c at a position lower than the other suspension lines, the light emitted from below is reflected in a C direction illustrated in FIG. 2. By adjusting the heights of the three suspension lines as described above, the reflecting member 121 can be rotated, and the angle of the light reflected by the reflecting member can be freely adjusted. Moreover, by adjusting the height of the suspension line, the reflecting member can be elevated up/down to an arbitrary height. Therefore, setting can be made such that the light is reflected at an arbitrary position to an arbitrary angle in the air of the stage.

FIG. 3 is a view illustrating an example of stage representation in this embodiment. Here, the example in which five elevating devices, five reflecting members, and five light sources are used is illustrated. As illustrated in FIG. 3, the light sources are set below the reflecting members (that is, elevating devices), respectively, and they emit light upward, respectively. Each of the reflecting members is installed at an arbitrary height by control of the elevating device to which the reflecting member is connected, respectively, and is further directed to an arbitrary angle by control of the elevating device. By actually performing such stage representation, for audience looking at the stage, the spotlight looks as if it is emitted from the air on the stage. That is, actual light is emitted from below the stage but for the audience looking at the stage, the light looks as if it is emitted from the reflecting member. Therefore, it looks as if the spotlight is arranged at an arbitrary position in the air (position of the reflecting member) and the spotlight is emitted from the arbitrary position in the air as illustrated in FIG. 3.

FIG. 3 illustrates only a still state, but on an actual stage, each of the reflecting members frequently repeats vertical movement and rotation in accordance with an instruction from the control device, and light is emitted from various positions to various angles. Particularly, in a dark environment such as an indoor stage, representation with new feeling such that the spotlight suddenly appears from the dark air can be experienced. Moreover, the reflecting member is much lighter in weight than the spotlight used as a light source, and its position or angle can be freely changed by the suspension lines. Therefore, since a rapid rise or a rapid drop of the reflecting member can be performed freely, new representation expression such that the position of the pseudo spotlight appearing in the air is dynamically changed can be performed. By relatively adjusting the positions and the angles in the air of the reflecting members and the emitting timing and angle of the spotlight constituted as above, dynamic stage representation can be performed.

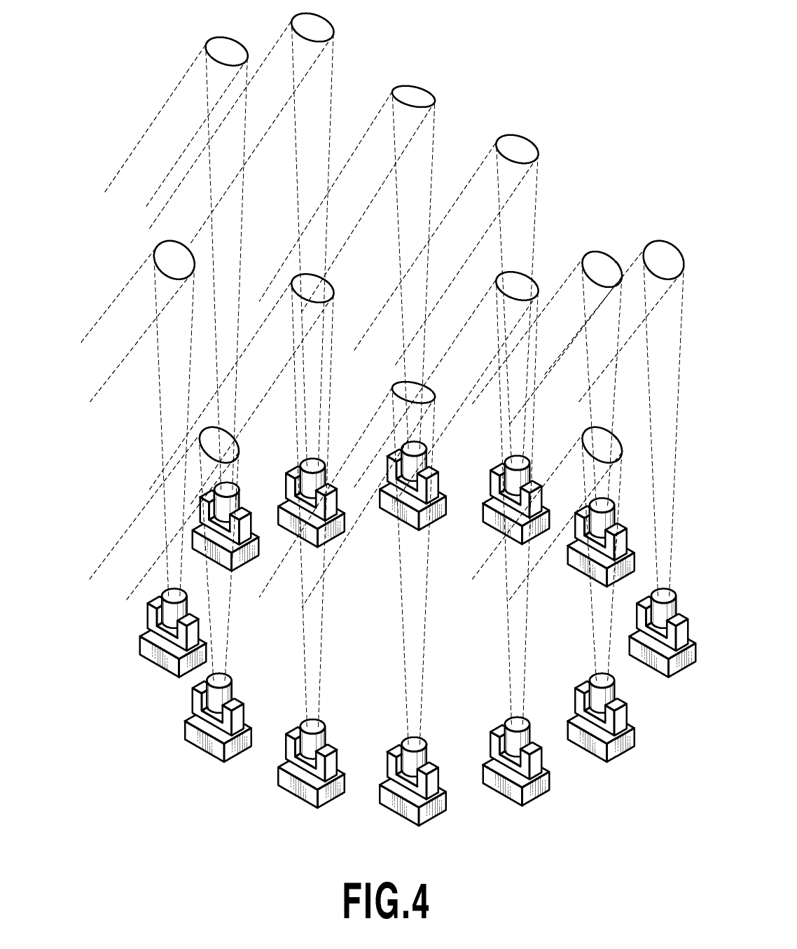

FIG. 4 is a view illustrating another example of the stage representation in this embodiment. In the example in FIG. 3, the reflecting members are arranged linearly on the single baton. However, the present invention is not limited to the example in FIG. 3, but diversified modes can be employed in accordance with representation purposes, effects and the like. In the example in FIG. 4, the reflecting members are arranged circularly. Though not shown, such circular arrangement can be made by using a plurality of the batons. In FIG. 4, the elevating devices, the baton, and the suspension lines are omitted for simplification of explanation. In the example in FIG. 4, an artist would sing a song or give a performance at the center. Then, the circular reflecting members arranged so as to surround therearound can realize effective representation as described above.

The reflecting member used in this embodiment is a light-weighted acrylic mirror having a weight of approximately 200 g as described above, and it makes appearance of a virtual spotlight possible at a much higher speed and at a much more flexible position than vertical movement of the lighting device itself. Moreover, such an acrylic mirror is excellent also in safety, and since it can be arranged at a position closer to the artist on the stage, various kinds of representation can be realized.

In this embodiment, the example in which the angle of the reflecting member is changed by using three suspension lines is described, but this example is not limiting. Any form can be employed as long as it has a configuration that allows the angle of the reflecting member to be changed.

Moreover, the example in which the light source is arranged below the reflecting member is described, but it may be arranged on the ceiling. Moreover, it may be arranged beside the stage. Moreover, the example in which the light source corresponds to the reflecting member in a one-to-one manner, but the one light source does not necessarily have to be arranged for the single reflecting member.

Moreover, in this embodiment, the example in which the reflecting member has a circular shape is described. This circular shape corresponds to a spot diameter of the spotlight of the light source, but this shape is not limiting. Moreover, an irregular surface may be formed on the reflecting member. By allowing the light to enter from the light source arranged above and below the reflecting member (ceiling and floor), for example, to the reflecting member on which the irregular surfaces are formed on upper and lower surfaces, the light is reflected differently between the upper and lower surfaces, and more diversified representation can be realized.

### Embodiment 2

In the embodiment 1, the example in which the reflecting member is suspended from the elevating device by using the suspension line is described. In an embodiment 2, an example in which a light source (lighting element) is provided on the reflecting member will be described.

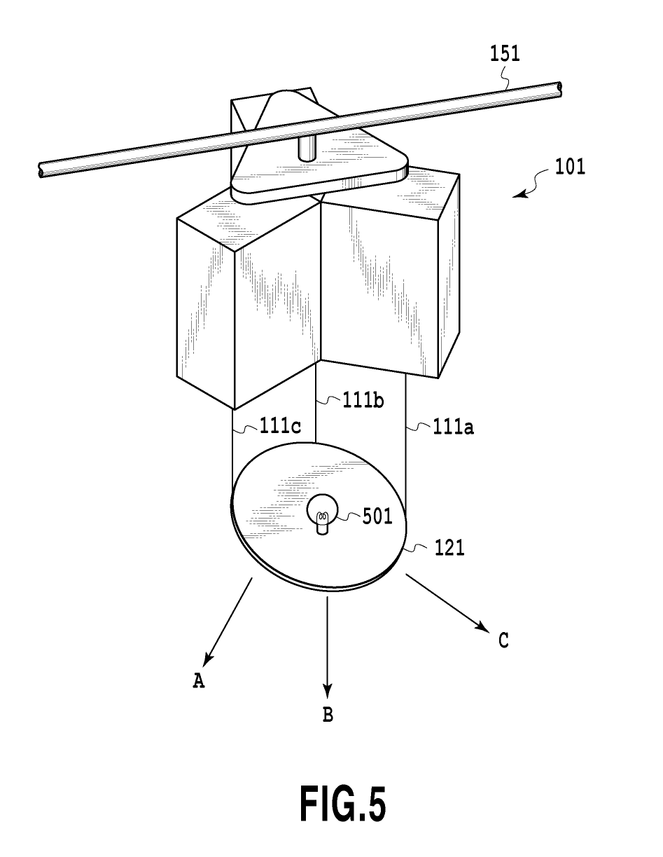

FIG. 5 is a view illustrating a part of the elevating device and the reflecting member in the embodiment 2. In FIG. 5, a lighting element 501 is provided on the reflecting member in addition to the example illustrated in FIG. 2. As the lighting element 501, an LED light bulb can be used, for example.

Since the lighting element is provided on the reflecting member, more diversified representation can be realized. For example, by turning on the lighting element in darkness, it can be used as a mark indicating from what position in the air a virtual spotlight using the reflecting member is emitted.

Moreover, those suspended from the elevating device can be a combination of the following three, that is, (1) only lighting element; (2) only the reflecting members and (3) the reflecting member on which the lighting element is provided. In the case of only the lighting element, it is only necessary that the lighting element is suspended from one suspension line illustrated in FIG. 5, for example. By combining as above, representation with a virtual spotlight can be also performed in addition to creation of a dynamic virtual object as disclosed by this applicant in Japanese Patent No. 5173231, for example.

### Other Embodiments

In the above-described embodiment 1 and embodiment 2, the examples in which the reflecting member is suspended from the elevating device by using the suspension line are described. However, the suspension line does not necessarily have to be used. The above-described vertical movement may be realized by providing a floating member such as a propeller of a helicopter on the reflecting member, for example. Moreover, the above-described rotating operation may be realized by changing an angle during hovering.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-217544, filed Oct. 18, 2013, which is hereby incorporated by reference wherein in its entirety.

What is claimed is:

1. A stage representation device comprising:
a spotlight installed on at least one of a ceiling, a wall, and a floor of a space in which a stage is performed;
a reflecting member connected to a suspension line and configured to reflect light from the spotlight;
an elevating unit configured to move a plurality of the reflecting members vertically in air in which the stage is performed by using a plurality of the suspension lines; and
a rotating unit configured to rotate the reflecting member in the air in which the stage is performed.

2. The stage representation device according to claim 1, wherein
each of the reflecting members reflects the light from at least one spotlight.

3. The stage representation device according to claim 1, wherein
the spotlight is installed on at least two different positions in the ceiling, the wall, and the floor of the space in which the stage is performed; and
the reflecting member reflects the light from the spotlights installed at the different positions from different directions on both surfaces in the air in which the stage is performed.

4. The stage representation device according to claim 1, wherein
the reflecting member further includes a fixed light bulb.

5. The stage representation device according to claim 1, further comprising:
a control unit configured to individually control elevation and rotation of each of the reflecting members in the elevating unit and the rotating unit.

6. The stage representation device according to claim 5, wherein
the reflecting member is connected to the elevating unit by the plurality of suspension lines; and
the control unit controls the elevation and rotation of the one reflecting member by controlling winding-up or winding-down of the plurality of suspension lines.

7. The stage representation device according to claim 5, wherein
the control unit further controls emitting timing, an emitting amount, and an emitting direction of the spotlight.

8. The stage representation device according to claim 7, wherein
the control unit dynamically executes control of elevation and rotation of the reflecting member and control of the emitting timing, the emitting amount, and the emitting direction of the spotlight on the basis of temporally changing information.

9. The stage representation device according to claim 1, wherein
the reflecting member is an acrylic mirror.

10. The stage representation device according to claim 1, wherein
the reflecting member has a shape corresponding to a spot diameter of the spotlight.

11. A stage representation device comprising:
a spotlight installed on at least one of a ceiling, a wall, and a floor of a space in which a stage is performed;
a reflecting member configured to reflect light from the spotlight;
a moving unit configured to move a plurality of the reflecting members to a predetermined position in air in which the stage is performed; and
a rotating unit configured to rotate the reflecting member at a predetermined position in the air.

12. A stage representation method using a reflecting member connected to a suspension line and configured to reflect light from a spot light installed on at least one of a ceiling, a wall, and a floor in a space in which a stage is performed and an elevating device configured to move a plurality of the reflecting members vertically in air in which the stage is performed by using a plurality of the suspension lines, the stage representation method comprising the step of:
dynamically controlling a position and an angle of the reflecting member in the air in which the stage is performed by a vertical movement of the suspension line using the elevating device.
